(19) United States
(12) Patent Application Publication
(10) Pub. No.: US 2023/0357050 A1
(43) Pub. Date: Nov. 9, 2023

(54) Regeneration Method of Waste Ternary Cathode Material and Application Thereof

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., Changsha (CN)

(72) Inventors: Peichao Ning, Foshan (CN); Changdong Li, Foshan (CN); Qiang Li, Foshan (CN); Ruokui Chen, Foshan (CN); Dingshan Ruan, Foshan (CN); Song Chen, Foshan (CN)

(21) Appl. No.: 18/223,023

(22) Filed: Jul. 17, 2023

Related U.S. Application Data
(63) Continuation of application No. PCT/CN2021/142773, filed on Dec. 30, 2021.

(30) Foreign Application Priority Data
Mar. 17, 2021 (CN) 202110286144.8

(51) Int. Cl. C01G 53/00; H01M 10/54; H01M 4/505; H01M 4/525

(52) U.S. Cl. CPC C01G 53/50; H01M 10/54; H01M 4/505; H01M 4/525; C01P 2006/40; C01P 2004/03; C01P 2002/85; C01P 2002/72; H01M 2004/028

(57) ABSTRACT

The invention belongs to the technical field of battery material recycling and discloses a regeneration method of waste ternary cathode materials and application thereof. The regeneration method comprises the following steps: drying, crushing, and sieving a waste ternary cathode material to obtain a cathode powder; adding the cathode powder to a alkali liquid, reacting, stirring, washing, and filtering to obtain a filter residue; drying the filter residue, then mixing with carbonized pitch, and performing reducing calcination to obtain a mixture; after testing the content of nickel, cobalt, manganese, aluminum, and lithium in the mixture, adding a nickel source, a cobalt source, a lithium source, a manganese source, polyethylene glycol, ball milling with water to obtain a suspension; spray granulating the suspension to obtain a ternary precursor; subjecting the precursor to two-stage calcination to obtain a regenerated ternary cathode material.

### CROSS-REFERENCE TO RELATED APPLICATIONS

The present application is a continuation application of PCT application No. PCT/CN2021/142773 filed on Dec. 30, 2021, which claims the benefit of Chinese Patent Application No. 202110286144.8 filed on Mar. 17, 2021. The contents of all of the aforementioned applications are incorporated by reference herein in their entirety.

### TECHNICAL FIELD

The invention belongs to the technical field of battery material recycling, and specifically relates to a regeneration method and application of waste ternary cathode materials.

### BACKGROUND

Since the commercialization of lithium-ion batteries at the end of the 20th century, they have been widely used in power supply, energy storage and 3C fields due to their advantages of high energy density, light weight, long life and no memory, etc. And the growth rate of demand for lithium batteries in power supply and energy storage fields is accelerating. After hundreds of cycles of charging and discharging of lithium ion batteries (LIBs), the positive and negative materials will experience structural failure, thickening of the SEI film, and irreversible physical and chemical changes such as transition metal leaching, which will hinder the intercalation/deintercalation of Li⁺ between the positive and negative electrodes and cause a sharp increase in the internal resistance of the battery, and finally cause an inactivation of LIBs. As a result, the average life of lithium-ion batteries is only 2-3 years. Ternary power lithium ion batteries contain a lot of valuable metals, generally in which Co accounts for about 5%-20%, Ni accounts for about 5%-12%, Mn accounts for about 7%-10%, and Li accounts for about 2%-5%. If these metals can be converted into reusable resources, huge economic benefits will be created.

At present, the main regeneration and recovery methods of used lithium-ion battery cathodes are: precipitation separation method, co-precipitation method, and physical repair and regeneration method. The precipitation separation method and the co-precipitation method refer to the processes of dissolving a waste LiNiₓCo_{y}Mn_{1-x-y}O₂ cathode material with inorganic acid or organic acid to obtain a solution containing ions such as Li⁺, Ni²⁺, Co²⁺, Mn and so on, and then adding a corresponding precipitation agent. The above-mentioned ions can be selectively precipitated into their corresponding metal salts, or precipitated as (NiₓCo_{y}Mn_{1-x-y})CO₃, NiₓCo_{y}Mn_{1-x-y}(OH)₂ at the same rate. And the metal salts can be used as a raw material for preparing a precursor again, while (NiₓCo_{y}Mn_{1-x-y})CO₃ and NiₓCo_{y}Mn_{1-x-y}(OH)₂ can be directly calcinated with supplement of lithium at a high temperature to obtain ternary cathode materials. In summary, the precipitation separation method and the co-precipitation method recover products with high purity, but the process flows are relatively complicated, with many control parameters, and various hazardous waste liquids and gases will be generated, which will cause secondary pollution. Physical repair and regeneration method rarely adopts inorganic or organic acids and produces less waste gas and waste water, hence can avoid these problems while well realize a harmless recycling of resources. The method mainly comprises the steps of directly calcinating and regenerating ternary materials whose capacity slightly faded after mixing with lithium. First, the lithium is supplemented by hydrothermal and molten salt, and then the high-temperature sintering in-situ reverse lithium supplementation is performed for repair and regeneration. This method can quickly realize the recycling and reuse of waste lithium ion battery cathode materials, but it has higher requirements for the electrochemical performance of waste ternary materials. More, more micro-cracks, etc.), it will be impossible to directly mix lithium calcination regeneration through physical methods. At the same time, for the current solid-phase regeneration, hydrothermal lithium regeneration, and molten salt lithium regeneration, the quality requirements of waste ternary cathode materials are relatively high. If it is possible to directly recycle and regenerate waste ternary cathode materials without quality classification, then a lot of costs can be saved.

### SUMMARY OF THE INVENTION

The present invention aims to solve at least one of the technical problems existing in the above-mentioned prior art. To this end, the present invention proposes a method and application for the regeneration of waste ternary cathode materials. The regeneration method can simplify the quality classification process, reduce the difficulty of waste liquid treatment, and realize huge economic benefits. The wasted ternary material is converted to the oxides by weakly reducing reaction, thereby solving the limitations of physical repair methods of used batteries.

In order to achieve the aforementioned objective, the following technical solution is adopted in the invention.

A regeneration method of waste ternary cathode materials comprises the following steps:

(1) Drying, crushing, and sieving a waste ternary cathode material to obtain a cathode powder;

(2) Adding the cathode powder to an alkali liquid, reacting, stirring, washing, and filtering to obtain a filter residue;

(3) Drying the filter residue, mixing it with carbonized pitch, and performing reducing calcination to obtain a mixture of nickel oxide, manganese oxide, cobalt oxide, and lithium carbonate;

(4) Testing the content of nickel, cobalt, manganese, aluminum, and lithium in the mixture, adding a nickel source, a cobalt source, a manganese source, a lithium source and polyethylene glycol, ball milling a resulting mixture, and adding water to obtain a suspension;

(5) Spray granulating the suspension to obtain a ternary precursor;

(6) Performing a two-stage calcination to the ternary precursor to obtain a regenerated ternary cathode material.

Preferably, in step (1), the drying is carried out at a temperature of 150° C. −200° C. for 1-3 h.

Preferably, in step (1), the sieving is carried out with a screen having a mesh size of 200-300 mesh.

Preferably, in step (2), the reacting is carried out at a temperature of 60° C.-90° C. for 10-60 min.

Preferably, in step (2), the alkali liquid is a sodium hydroxide solution, and the temperature of the sodium hydroxide solution is 50° C.-70° C. The high temperature can accelerate the reaction of NaOH with aluminum in the cathode powder, thereby reducing the impurity aluminum content.

More preferably, the concentration of the sodium hydroxide solution is 1-5 mol/L.

Preferably, in step (3), the mass ratio of the cathode powder to the carbonized pitch is 1: (0.3-1.0); the reducing calcination is carried out at a temperature of 450° C.-750° C. for 3-5 h.

Preferably, in step (3), the carbonized pitch is obtained by calcinating a pitch in an inert atmosphere at 1000° C.-1300° C. for 1-3 h.

More preferably, the inert atmosphere is one of nitrogen, helium or argon.

Preferably, in step (4), the mass ratio of the polyethylene glycol to the cathode powder is 1: (0.1-0.30); the mass-volume ratio of the resulting mixture to water is (0.1-0.5): 1 g/mL.

Preferably, in step (4), the nickel source, the manganese source and the cobalt source are added according to a Ni:Co:Mn molar ratio of 6:2:2, 1:1:1, 5:2:3 or 8:1:1.

Preferably, in step (4), the lithium source is at least one selected from the group consisting of LiGH, lithium acetate and Li₂CO₃.

Preferably, in step (4), the nickel source is at least one selected from the group consisting of NiC₄H₆O₄·4H₂O and Ni(NO₃)₂·6H₂O.

Preferably, in step (4), the cobalt source is at least one selected from the group consisting of CoC₄H₆O₄·4H₂O and Co(NO₃)₂·6H₂O.

Preferably, in step (4), the manganese source is at least one selected from the group consisting of MnC₄H₆O₄·4H₂O and Mn (NO₃)₂·6H₂O.

Preferably, in step (4), the ball milling is carried out with a superfine ball miller; the rotation speed of the ball miller is 600-1000 r/min, and the ball milling time is 3-10 h.

Preferably, in step (5), the spray granulation is carried out with a spray dryer under the following condition: the spray temperature is 170-190° C., the feed rate is 300-650 mL/h, the inlet pressure is 0.1-0.5 MPa, and the outlet temperature is 120-150° C.

Preferably, in step (6), the specific steps of the two-stage calcination are: subjecting the ternary precursor to a first stage calcination, raising the temperature, and then performing a second stage calcination; the first stage calcination is carried out at a temperature of 400° C.-500° C. for 5-8 h; the second stage calcination is carried out at a temperature of 700° C.-900° C. for 10-20 h.

Reaction principle of step (3) is as follows:

LiNiₓCo_{y}Mn_{1-x-y}O₂+pitch→xNiO+yMnO+(1-x-y)CoO+Li₂CO₃+H₂O+CO₂

The present invention also provides the application of the above-mentioned regeneration method in processing a cathode material of ternary batteries.

Compared with the prior art, the beneficial effects of the present invention are as follows:

1. In view of the disadvantages of the prior art that physical regeneration methods have high requirement on electrochemical performance of waste batteries, the present invention mainly uses weak reducing reaction to convert waste ternary materials to the oxides, thereby overcoming the limitations of the physical regeneration method of waste batteries. Wherein the carbonized pitch has weak reducibility, which can avoid the conversion of waste ternary materials into Ni, Co, Mn element but into NiO, MnO, CoO, Li₂CO₃ which are then synthesized a new cathode material in situ again. But the solid-phase reaction area among the oxides is small, by mixing the oxides at a molecular level through ultra-fine ball milling, the oxides react more completely, and then a cathode material with better performance can be synthesized. This process does not require complicated control conditions and can realize a maximum recovery degree of the elements.

2. The regenerated ternary cathode material of the present invention has a better α-NaFeO₂ layered structure, the crystal structure is good without the presence of impure phases.

3. By controlling the ratio of the carbonized pitch and the waste ternary lithium battery cathode powder as well as the ball milling parameters, the present invention can meet the production requirements of different series of ternary material products through spray drying. The method is easy operated, pollution-free, and has obvious economic benefits. The method provides a new idea for recycling and regeneration of lithium battery ternary cathode materials and has huge industrial application prospects.

### BRIEF DESCRIPTION OF DRAWINGS

The present invention will be further described below in conjunction with the accompanying drawings and embodiments, in which:

FIG. 1 is an SEM image of the NCM precursor prepared in Example 1 of the present invention;

FIG. 2 is an element distribution EDS diagram of the regenerated ternary cathode material NCM523 prepared in Example 1 of the present invention;

FIG. 3 is a electrochemical performance graph of the regenerated ternary cathode material NCM523 prepared in Example 1 of the present invention;

FIG. 4 is an XRD diagram of the regenerated ternary cathode material NCM111 prepared in Example 2 of the present invention;

FIG. 5 is a comparison diagram of the electrochemical performance of the regenerated ternary material after reduction and ball milling with the regenerated ternary material after direct calcination and ball milling.

FIG. 6 is an SEM image of the regenerated ternary cathode material NCM811 prepared in Example 3 of the present invention.

### DETAILED DESCRIPTION OF ILLUSTRATED EXAMPLES

Hereinafter, the concept of the present invention and the technical effects produced by it will be described clearly and completely with reference to the embodiments, to fully understand the purpose, features and effects of the present invention. Obviously, the described embodiments are only a part of the embodiments of the present invention, rather than all of them. Based on the embodiments of the present invention, other embodiments obtained by those skilled in the art without creative work belong to the protection scope of the present invention.

### Example 1

The specific steps of the regeneration method of the waste ternary cathode material of this embodiment are as follows:

(1) Placing a waste NCM523 (LiNi_{0.5}Co_{0.2}Mn_{0.3}O₂) lithium battery pack with serious battery capacity degradation in 3 mol/L Na₂SO₄ solution for 10 h for discharge treatment, and cutting and removing the aluminum shell to obtain a cell and an outer shell respectively;

(2) Disassembling the cell obtained in step (1) to obtain a positive electrode sheet, a negative electrode sheet, a separator and tabs, and then drying the positive electrode sheet at 200° C. for 1 h;

(3) Crushing the positive electrode sheet obtained in step (2), and sieving with a 200 mesh screen to obtain a cathode powder;

(4) Placing the cathode powder obtained in step (3) in 3 mol/L NaOH solution, heating to 75° C. and stirring for 50 min, then removing aluminum from the battery powder, repeating the above steps more than three times, and then rinsing with deionized water for more than three times to remove sodium ions in the battery powder and filtering to obtain a filter residue;

(5) Drying the filter residue obtained in step (4) in a drying box at 100° C. for 10 h to remove the moisture from the filter residue;

(6) Mixing the filter residue obtained in step (5) with carbonized pitch (the carbonization process is to calcinate the pitch at 1150° C. under an inert atmosphere for 2 h) in a mass ratio of 1:0.7, and calcinating in an inert atmosphere at 600° C. for 4 h to obtain a mixture of NiO, MnO, CoO, and Li₂CO₃;

(7) Testing the content of nickel, cobalt, manganese and lithium in the mixture obtained in step (6), adding NiC₄H₆O₄-4H₂O, CoC₄HO₄·4H₂O, MnC₄H₆O₄·4H₂O, C₂H₃O₂Li in proportion, and adding polyethylene glycol (mass ratio of the polyethylene glycol to the waste cathode material powder is 0.2), followed by adding water and the mass-volume ratio of the mixture to the water is 0.3:1 g/mL, and then ball milling a resulting mixture in a ball miller at a rotation speed of 750 r/min for 7 h to obtain suspension with homogeneous composition.

(8) Adding the suspension obtained in step (7) to a spray dryer, and spray granulating under a condition that the temperature is controlled to be 180° C., the feed rate is 450 mL/h, the inlet pressure is 0.5 MPa, and the outlet temperature is 150° C., to obtain a spherical NCM523 precursor after continuously performing the process;

(9) Placing the NCM precursor prepared in step (8) in a muffle furnace, and performing a two-stage calcination with addition of industrial oxygen. The first stage calcination comprises the steps of: heating up to a temperature of 500° C. and holding the temperature for 5 h while the second stage calcination is performed by heating up to 850° C. and holding for 15 h. The regenerated ternary cathode material NCM523 is obtained.

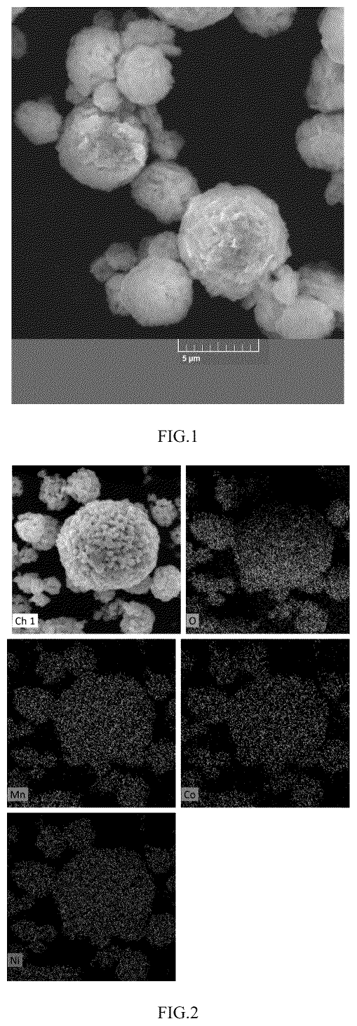

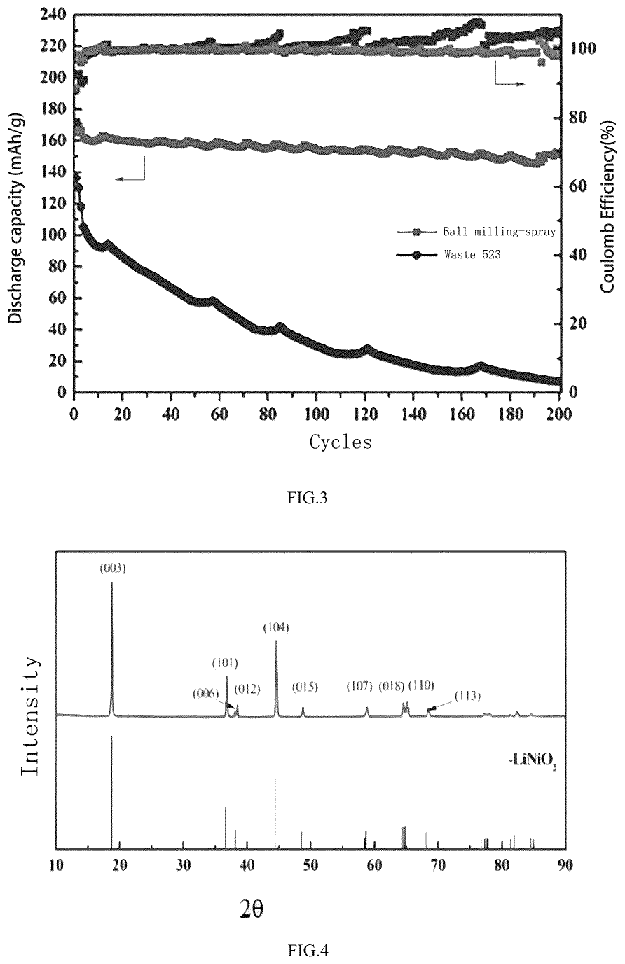

FIG. 1 is an SEM image of the NCM precursor prepared in Example 1. It can be seen from the figure that the precursor is in a near-spherical shape with a diameter of 1-7 μm. FIG. 2 is an EDS diagram of the ternary cathode material prepared in Example 1. It can be seen that the elements of Ni, Co, Mn, and O are uniformly distributed, indicating that the element segregation is low and the material is uniform.

### Example 2

The specific steps of the regeneration method of the waste ternary cathode material of this embodiment are as follows:

(1) Placing a waste NCM111 (LiNi_{0.3}Co_{0.3}Mn_{0.3}O₂) lithium battery pack with serious battery capacity degradation in 3 mol/L Na₂SO₄ solution for 10 h for discharge treatment, and cutting and removing the aluminum shell to obtain a cell and an outer shell respectively;

(2) Disassembling the cell obtained in step (1) to obtain a positive electrode sheet, a negative electrode sheet, a separator and tabs, and then drying the positive electrode sheet at 150° C. for 3 h;

(3) Crushing the positive electrode sheet obtained in step (2), and sieving with a 200 mesh screen to obtain a cathode powder;

(4) Placing the cathode powder obtained in step (3) in 1 mol/L NaOH solution, heating to 90° C. and stirring for 10 min, then removing aluminum from the battery powder, repeating the above steps more than three times, and then rinsing with deionized water for more than three times to remove sodium ions in the battery powder and filtering to obtain a filter residue;

(5) Drying the filter residue obtained in step (4) in a drying box at 100° C. for 10 h to remove the moisture from the filter residue;

(6) Mixing the filter residue obtained in step (5) with carbonized pitch (the carbonization process is to calcinate the pitch at 1150° C. under an inert atmosphere for 2 h) in a mass ratio of 1:0.7, and calcinating in an inert atmosphere at 600° C. for 4 h to obtain a mixture of NiO, MnO, CoO, and Li₂CO₃;

(7) Testing the content of nickel, cobalt, manganese and lithium in the mixture obtained in step (6), adding NiC₄H₆O₄·4H₂O, CoC₄HO₄·4H₂O, MnC₄H₆O₄·4H₂O, C₂H₃O₂Li in proportion, and adding polyethylene glycol (mass ratio of the polyethylene glycol to the waste cathode material powder is 0.1), followed by adding water and the mass-volume ratio of the mixture to the water is 0.5:1 g/mL, and then ball milling a resulting mixture in a ball miller at a rotation speed of 1000 r/min for 3 h to obtain suspension with homogeneous composition.

(8) Adding the suspension obtained in step (7) to a spray dryer, and spray granulating under a condition that the temperature is controlled to be 170° C., the feed rate is 650 mL/h, the inlet pressure is 0.1 MPa, and the outlet temperature is 120° C., to obtain a spherical NCM111 precursor after continuously performing the process;

(9) Placing the NCM precursor prepared in step (8) in a muffle furnace, and performing a two-stage calcination with addition of industrial oxygen. The first stage calcination comprises the steps of heating up to a temperature of 450° C. and holding the temperature for 6 h while the second stage calcination is performed by heating up to 900° C. and holding for 12 h. The regenerated ternary cathode material NCM111 is obtained.

### Example 3

The specific steps of the regeneration method of the waste ternary cathode material of this embodiment are as follows:

(1) Placing a waste NCM811 (LiNi_{0.8}Co_{0.1}Mn_{0.1}O₂) lithium battery pack battery capacity in 3 mol/L Na₂SO₄ solution for 10 h for discharge treatment, and cutting and removing the aluminum shell to obtain a cell and an outer shell respectively;

(2) Disassembling the cell obtained in step (1) to obtain a positive electrode sheet, a negative electrode sheet, a separator and tabs, and then drying the positive electrode sheet at 170° C. for 2 h;

(3) Crushing the positive electrode sheet obtained in step (2), and sieving with a 250 mesh screen to obtain a cathode powder;

(4) Placing the cathode powder obtained in step (3) in 5 mol/L NaOH solution, heating to 60° C. and stirring for 60 min, then removing aluminum from the battery powder, repeating the above steps more than three times, and then rinsing with deionized water for more than three times to remove sodium ions in the battery powder and filtering to obtain a filter residue;

(5) Drying the filter residue obtained in step (4) in a drying box at 100° C. for 10 h to remove the moisture from the filter residue;

(6) Mixing the filter residue obtained in step (5) with carbonized pitch (the carbonization process is to calcinate the pitch at 1000° C. under an inert atmosphere for 3 h) in a mass ratio of 1:1.0, and calcinating in an inert atmosphere at 450° C. for 5 h to obtain a mixture of NiO, MnO, CoO, and Li₂CO₃;

(7) Testing the content of nickel, cobalt, manganese and lithium in the mixture obtained in step (6), adding NiC₄H₆O₄·4H₂O, CoC₄HO₄·4H₂O, MnC₄H₆O₄·4H₂O, C₂H₃O₂Li in proportion, and adding polyethylene glycol (mass ratio of the polyethylene glycol to the waste cathode material powder is 0.3), followed by adding water and the mass-volume ratio of the mixture to the water is 0.1:1 g/mL, and then ball milling a resulting mixture in a ball miller at a rotation speed of 600 r/min for 10 h to obtain suspension with homogeneous composition.

(8) Adding the suspension obtained in step (7) to a spray dryer, and spray granulating under a condition that the temperature is controlled to be 190° C., the feed rate is 450 mL/h, the inlet pressure is 0.3 MPa, and the outlet temperature is 130° C., to obtain a spherical NCM111 precursor after continuously performing the process;

(9) Placing the NCM precursor prepared in step (8) in a muffle furnace, and performing a two-stage calcination with addition of industrial oxygen. The first stage calcination comprises the steps of heating up to a temperature of 400° C. and holding the temperature for 8 h while the second stage calcination is performed by heating up to 700° C. and holding for 20 h. The regenerated ternary cathode material is obtained.

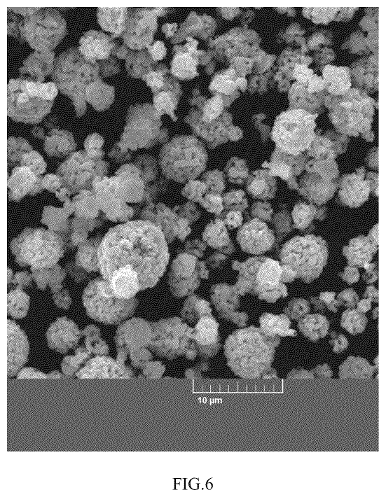

FIG. 6 is an SEM image of the ternary cathode material prepared in Example 3. It can be seen from the figure that most of the particles of the ternary cathode material regenerated are spherical secondary particles composed of small primary particles and having a dense surface. It is helpful to prevent the electrolyte from corroding the inside of the particles.

### Comparative Example 1

Comparative example is the patent application CN112186287A.

### Comparative Example 2

The specific steps of the regeneration method of the waste ternary cathode material of this embodiment are as follows:

(1) Placing a waste NCM523 (LiNi_{0.5}Co_{0.2}Mn_{0.3}O₂) lithium battery pack in 3 mol/L Na₂SO₄ solution for 10 h for discharge treatment, and cutting and removing the aluminum shell to obtain a cell and an outer shell respectively;

(2) Disassembling the cell obtained in step (1) to obtain a positive electrode sheet, a negative electrode sheet, a separator and tabs, and then drying the positive electrode sheet at 200° C. for 1 h;

(3) Crushing the positive electrode sheet obtained in step (2), and sieving with a 200 mesh screen to obtain a cathode powder;

(4) Placing the cathode powder obtained in step (3) in 3 mol/L NaOH solution, heating to 75° C. and stirring for 50 min, then removing aluminum from the battery powder, repeating the above steps more than three times, and then rinsing with deionized water for more than three times to remove sodium ions in the battery powder and filtering to obtain a filter residue;

(5) Drying the filter residue obtained in step (4) in a drying box at 100° C. for 10 h to remove the moisture from the filter residue;

(6) Mixing the filter residue obtained in step (5) with a weak reducing agent (glucose and citric acid) in a mass ratio of 1:0.7, and calcinating in an inert atmosphere at 600° C. for 4 h to obtain a mixture of NiO, MnO, CoO, and Li₂CO₃;

(7) Testing the content of nickel, cobalt, manganese and lithium in the mixture obtained in step (6), adding NiC₄H₆O₄·4H₂O, CoC₄HO₄·4H₂O, MnC₄H₆O₄·4H₂O, C₂H₃O₂Li in proportion, and adding polyethylene glycol (mass ratio of the polyethylene glycol to the waste cathode material powder is 0.2), followed by adding water and the mass-volume ratio of the mixture to the water is 0.3:1 g/mL, and then ball milling a resulting mixture in a ball miller at a rotation speed of 750 r/min for 7 h to obtain suspension with homogeneous composition.

(8) Adding the suspension obtained in step (7) to a spray dryer, and spray granulating under a condition that the temperature is controlled to be 180° C., the feed rate is 450 mL/h, the inlet pressure is 0.5 MPa, and the outlet temperature is 150° C., to obtain a spherical NCM523 precursor after continuously performing the process;

(9) Placing the NCM precursor prepared in step (8) in a muffle furnace, and performing a two-stage calcination with addition of industrial oxygen. The first stage calcination comprises the steps of: heating up to a temperature of 500° C. and holding the temperature for 5 h while the second stage calcination is performed by heating up to 850° C. and holding for 15 h. The regenerated ternary cathode material NCM523 is obtained.

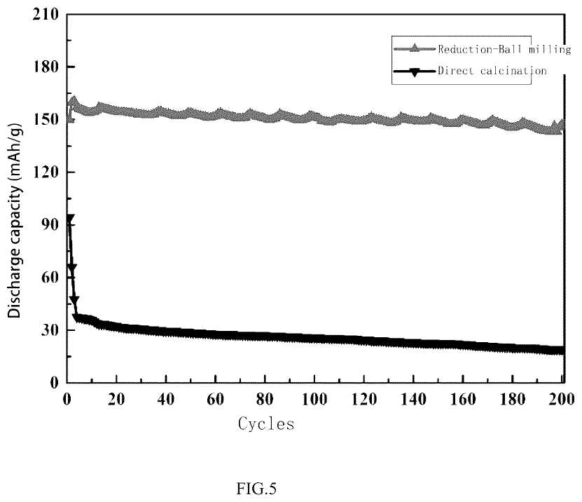

Compared with Comparative Example 1, FIG. 3 is a graph showing the electrochemical performance of the regenerated ternary cathode material NCM523 prepared in Example 1 of the present invention. The battery with the waste ternary cathode material has a discharge specific capacity of only about 100 mAh/g at 1C which decays fast, indicating that the electrochemical performance of the waste ternary cathode material is poor. The waste battery adopted in Comparative Example 1 has a discharge specific capacity of about 130 mAh/g at 1C, having a better cycle performance. In view of the electrochemical performance of the regenerated ternary cathode material, the first-cycle discharge specific capacity at 0.1C is 165.4 mA h/g, the first-cycle specific capacity at 1C is 161.6 mAh/g, and after 100 cycles of charging and discharging, the capacity retention rate is 94.8%, indicating that the positive electrode material prepared by regeneration has good electrochemical performance. FIG. 4 is an XRD pattern of the ternary cathode material prepared in Example 2. It can be seen that the regenerated ternary cathode material has a better α —NaFeO2 layered structure without the presence of miscellaneous phases and a good crystal structure.

FIG. 5 is a comparison diagram of the electrochemical performance of the regenerated ternary material obtained by reduction followed by ball milling with direct calcination followed by ball milling. It can be seen from FIG. 5 that obtained by direct calcination followed by ball milling, the specific capacity is only 94.2 mAh/g at 0.1C, the specific capacity is only 37.4 mAh/g at 1C, and the 200-cycles specific capacity is 19 mAh/g. Obtained by reduction and ball milling, the material's specific capacity has changed greatly. The first-cycle specific capacity of at 1C is 156.9 mAh/g, and the 200-cycles capacity retention rate is 94.0%. It is indicated that the electrochemical performance of the waste battery has suffered serious irreversible damage, and direct lithium supplementation through physical methods is not applicable. The only way is to convert the ternary material into corresponding oxides through weak reduction and calcination, and then a new cathode material is synthesized in-situ again. The present invention can indeed repair batteries that cannot be regenerated by physical methods.

The embodiments of the present invention have been described in detail above with reference to the accompanying drawings. However, the present invention is not limited to the above-mentioned embodiments. Within the scope of knowledge possessed by those of ordinary skill in the art, various change can be made without departing from the purpose of the present invention. In addition, in the case of no conflict, the embodiments of the present invention and the features in the embodiments can be combined with each other.

1. A regeneration method of a waste ternary cathode material, comprising the following steps:
(1) drying, crushing, and sieving a waste ternary cathode material to obtain a cathode powder;
(2) adding the cathode powder to an alkali liquid, reacting, stirring, washing, and filtering to obtain a filter residue;
(3) drying the filter residue, mixing it with carbonized pitch, and performing reducing calcination to obtain a mixture of nickel oxide, manganese oxide, cobalt oxide, and lithium carbonate, a mass ratio of the filter residue to the carbonized pitch is 1: (0.7-1.0);
(4) testing the content of nickel, cobalt, manganese, aluminum, and lithium in the mixture, adding a nickel source, a cobalt source, a manganese source, a lithium source and polyethylene glycol, ball milling a resulting mixture, and adding water to obtain a suspension;
(5) spray granulating the suspension to obtain a ternary precursor; and
(6) performing a two-stage calcination to the ternary precursor to obtain a regenerated ternary cathode material.

2. The regeneration method of claim 1, wherein in step (1), the drying is carried out at a temperature of 150° C. −200° C. for 1-3 h.

3. The regeneration method of claim 1, wherein in step (2), the alkali liquid is a sodium hydroxide solution, and the temperature of the sodium hydroxide solution is 50° C.-70° C.; the concentration of the sodium hydroxide solution is 1-5 mol/L.

4. The regeneration method of claim 1, wherein in step (4), the lithium source is at least one selected from the group consisting of LiGH, lithium acetate and Li₂CO₃.

5. The regeneration method of claim 1, wherein in step (4), the nickel source is at least one selected from the group consisting of NiC₄H₆O₄·4H₂O and Ni(NO₃)₂·6H₂O; the cobalt source is at least one selected from the group consisting of CoC₄H₆O₄·4H₂O and Co(NO₃)₂·6H₂O; the manganese source is at least one selected from the group consisting of MnC₄H₆O₄·4H₂O and Mn (NO₃)₂·6H₂O.

6. The regeneration method of claim 1, wherein in step (4), the ball milling is carried out with a superfine ball miller; the rotation speed of the ball miller is 600-1000 r/min, and the ball milling time is 3-10 h.

7. The regeneration method of claim 1, wherein in step (5), the spray granulation is carried out with a spray dryer under the following condition: the spray temperature is 170-190° C., the feed rate is 300-650 mL/h, the inlet pressure is 0.1-0.5 MPa, and the outlet temperature is 120-150° C.

8. The regeneration method of claim 1, wherein in step (6), the specific steps of the two-stage calcination are: subjecting the ternary precursor to a first stage calcination, raising the temperature, and then performing a second stage calcination; the first stage calcination is carried out at a temperature of 400° C.-500° C. for 5-8 h; the second stage calcination is carried out at a temperature of 700° C.-900° C. for 10-20 h.

9. Use of the regeneration method of claim 1 in treatment of ternary cathode materials.

10. Use of the regeneration method of claim 2 in treatment of ternary cathode materials.

11. Use of the regeneration method of claim 3 in treatment of ternary cathode materials.

12. Use of the regeneration method of claim 4 in treatment of ternary cathode materials.

13. Use of the regeneration method of claim 5 in treatment of ternary cathode materials.

14. Use of the regeneration method of claim 6 in treatment of ternary cathode materials.

15. Use of the regeneration method of claim 7 in treatment of ternary cathode materials.

16. Use of the regeneration method of claim 8 in treatment of ternary cathode materials.
